(19) United States
(12) Patent Application Publication
(10) Pub. No.: US 2016/0268009 A1
(43) Pub. Date: Sep. 15, 2016

(54) Cooling System of Reactor Suppression Pool

(71) Applicant: Hitachi-GE Nuclear Energy, Ltd., Hitachi-shi, Ibaraki (JP)

(72) Inventors: Masaki KASHIYAMA, Hitachi (JP); Yukiko KUSHIMA, Hitachi (JP)

(21) Appl. No.: 15/031,768

(22) PCT Filed: Oct. 21, 2014
(86) PCT No.: PCT/JP2014/077918

§ 371 Date: Apr. 25, 2016

(30) Foreign Application Priority Data
Nov. 7, 2013 (JP) 2013-231085

(51) Int. Cl. G21C 15/18; G21C 9/004

(52) U.S. Cl. CPC G21C 15/18; G21C 9/004; G21Y 2002/50; G21Y 2004/30

(57) ABSTRACT

To provide a cooling system of a reactor suppression pool capable of cooling suppression pool water and improving the safety of a reactor in the case where an event surpassing a postulated initiating event occurs, or in the case where cooling of the suppression pool water by a residual heat removable system does not function. A cooling system of a reactor suppression pool according to the present invention includes a heat exchanger for cooling suppression pool water installed in the middle of a suppression pool water cooling line, operating when the temperature of the suppression pool water reaches a given temperature, performing heat exchange with the suppression pool water from a suppression pool water cleanup system suction line to cool the water, and returning the cooled suppression pool water to the suppression pool through a suppression pool water cleanup system discharge line.

### TECHNICAL FIELD

The present invention relates to a cooling system of a reactor suppression pool, and particularly relates to a cooling system of a reactor suppression pool suitable to be used when an event surpassing a postulated initiating event occurs.

### BACKGROUND ART

As a background art in this technical field, there exists a suppression pool water cleanup system disclosed in Patent Literature 1. In Patent Literature 1, there is disclosed a system in which suppression pool water stored in a suppression pool arranged in a reactor containment vessel in a reactor building forming a nuclear power plant is introduced into a filtration demineralizer installed in a fuel pool cooling and cleanup system through the suppression pool water cleanup system and the suppression pool water is cleaned up by the filtration demineralizer.

Incidentally, when a large-scale postulated initiating event such as a loss of coolant accident occurs in the nuclear power plant, a reactor coolant (steam) flows into the suppression pool from a reactor pressure vessel and the steam is condensed by the suppression pool to thereby reduce the pressure inside the reactor pressure vessel. The suppression pool water stored in the suppression pool is a water source for injecting water to the reactor, therefore, the reactor pressure vessel is cooled by injecting water from respective reactor injection systems. Accordingly, the suppression pool is in a high-temperature and high-pressure state, the suppression pool water is cooled by a residual heat removable system at that time, and sufficient safety measures are taken with respect to the above-described large-scale postulated initiating event.

### CITATION LIST

### Patent Literature

Patent Literature 1: JP-A-3-255394

### SUMMARY OF INVENTION

### Technical Problem

However, in recent years, in the case where an event surpassing the postulated initiating event occurs and in the case where taken measures do not function due to some reasons, strengthening measures of defense in depth are taken from the viewpoint that the safety of nuclear should be secured.

Accordingly, it is necessary to diversify the cooling system of the suppression pool water for further improving a safety margin of nuclear. However, in the above Patent Literature 1, the cooling of the suppression pool water has not been considered at all.

The present invention has been made in view of the above problems, and an object thereof is to provide a cooling system of a reactor suppression pool capable of cooling suppression pool water and improving the safety of the reactor in the case where the event surpassing the postulated initiating event occurs, or in the case where cooling of the suppression pool water by the residual heat removable system does not function.

### Solution to Problem

According to an embodiment of the present invention, to achieve the object, there is provided a cooling system of a reactor suppression pool for cooling a suppression water stored in the suppression pool arranged in a reactor containment vessel in which a reactor is housed, which includes a suppression pool water cleanup system suction line sucking the suppression pool water from the suppression pool and allows the water to flow, a suppression pool water cleanup system pump installed in the middle of the suppression pool water cleanup system suction line, a fuel pool cooling and cleanup system line one end of which is connected to the suppression pool water cleanup system suction line, a filtration demineralizer installed in the middle of the fuel pool cooling and cleanup system line and cleaning up the suppression pool water flowing in the fuel pool cooling and cleanup system line, a suppression pool water cleanup system discharge line connected to the other end of the fuel pool cooling and cleanup system line and returning the suppression pool water cleaned up by the filtration demineralizer to the suppression pool, a suppression pool water cooling line one end of which is connected to a line connecting between the suppression pool water cleanup system suction line and the fuel pool cooling and cleanup system line on an inlet side to the filtration demineralizer and the other end of which is connected to a line connecting between the fuel pool cooling and cleanup system line on an outlet side to the filtration demineralizer and the suppression pool water cleanup system discharge line and a heat exchanger for cooling suppression pool water installed in the middle of the suppression pool water cooling line, operating when the temperature of the suppression pool water reaches a given temperature, performing heat exchange with the suppression pool water from the suppression pool water cleanup system suction line to cool the water, and returning the cooled suppression pool water to the suppression pool through the suppression pool water cleanup system discharge line.

### Advantageous Effects of Invention

According to the present invention, there are advantages that cooling of the suppression water can be performed, the safety of the reactor is improved and the defense in depth is reinforced even in the case where the event surpassing the postulated initiating event occurs, or in the case where cooling of the suppression pool water by the residual heat removable system does not function.

### BRIEF DESCRIPTION OF DRAWINGS

FIG. 1 is a schematic configuration diagram showing Embodiment 1 of a cooling system of a reactor suppression pool according to the present invention.

FIG. 2 is a schematic configuration diagram showing Embodiment 2 of a cooling system of a reactor suppression pool according to the present invention.

FIG. 3 is a schematic configuration diagram showing Embodiment 3 of a cooling system of a reactor suppression pool according to the present invention.

FIG. 4 is a schematic configuration diagram showing Embodiment 4 of a cooling system of a reactor suppression pool according to the present invention.

FIG. 5 is a schematic configuration diagram showing Embodiment 5 of a cooling system of a reactor suppression pool according to the present invention.

### DESCRIPTION OF EMBODIMENTS

Hereinafter, a cooling system of a reactor suppression pool according to an embodiment of the present invention will be explained with reference to the shown embodiments. In respective embodiments, the same numerals are used for the same components.

### Embodiment 1

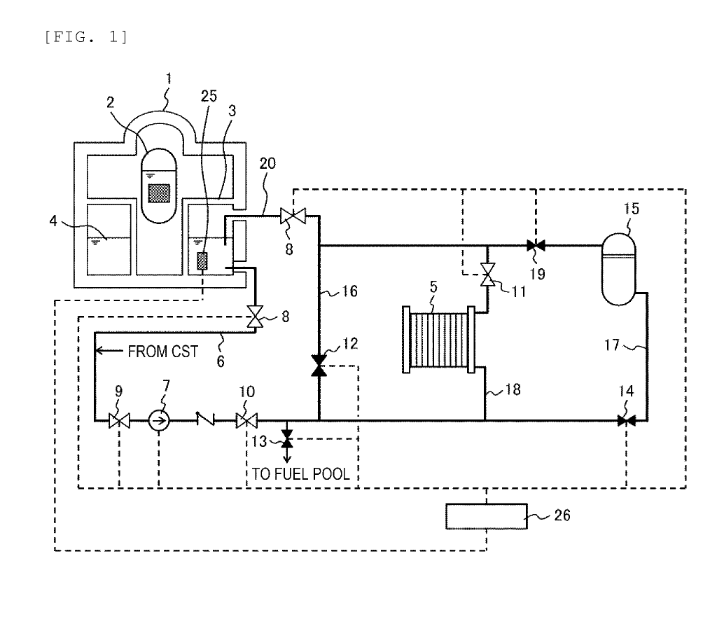

FIG. 1 shows Embodiment 1 of a cooling system of a reactor suppression pool according to the present invention.

In the drawing, 1 denotes a reactor containment vessel, a reactor 2 is housed in the reactor containment vessel 1 and a suppression pool 3 storing a suppression pool water 4 for suppressing the pressure increase inside the reactor containment vessel 1 is installed in a lower part of the reactor containment vessel 1.

The cooling system of the reactor suppression pool according to the embodiment includes a suppression pool water cleanup system suction line 6 sucking the suppression pool water 4 from the suppression pool 3 and allows the water to flow for cleaning up the suppression water 4 stored in the suppression pool 3, a suppression pool water cleanup system pump 7 installed in the middle of the suppression pool water cleanup system suction line 6, a fuel pool cooling and cleanup system line 17 one end of which is connected to the suppression pool water cleanup system suction line 6, a filtration demineralizer 15 installed in the middle of the fuel pool cooling and cleanup system line 17 and cleaning up the suppression pool water 4 flowing in the fuel pool cooling and cleanup system line 17, and a suppression pool water cleanup system discharge line 20 connected to the other end of the fuel pool cooling and cleanup system line 17 and returning the suppression pool water 4 cleaned up by the filtration demineralizer 15 to the suppression pool 3 for cleaning up the suppression pool water 4 stored in the suppression pool 3.

Suppression pool isolation valves 8 are installed in the suppression pool water cleanup system suction line 6 and the suppression pool water cleanup system discharge line 20, a suppression pool water cleanup system pump inlet valve 9 and a suppression pool water cleanup system pump outlet valve 10 are respectively installed on an inlet side and an outlet side of the suppression pool water cleanup system pump 7, a fuel pool cooling and cleanup system line inlet valve 14 and a fuel pool cooling and cleanup system line outlet valve 19 are respectively installed in the fuel pool cooling and cleanup system line 17 on an inlet side and an outlet side of the filtration demineralizer 15, and a fuel pool line inlet valve 13 which opens and closes a line to a fuel pool (not shown) is installed in the line.

The suppression pool water cleanup system suction line 6 and the suppression pool water cleanup system discharge line 20 are connected by a suppression pool water cleanup system surveillance line 16 used at the time of performing a performance validation test of the suppression pool water cleanup system pump 7, and a suppression pool water cleanup system surveillance line valve 12 is provided in the middle of the suppression pool water cleanup system surveillance line 16.

In the embodiment, there is formed a suppression pool water cooling line 18 one end of which is connected to a line connecting between the suppression pool water cleanup system suction line 6 and the fuel pool cooling and cleanup system line 17 on the inlet side to the filtration demineralizer 15, and the other end of which is connected to a line connecting between the fuel pool cooling and cleanup system line 17 on the outlet side to the filtration demineralizer 15 and the suppression pool water cleanup system discharge line 20, and there is provided a heat exchanger for cooling suppression pool water 5 installed in the middle of the suppression pool water cooling line 18, operating when the temperature of the suppression pool water 4 reaches a given temperature, performing heat exchange with the suppression pool water 4 from the suppression pool water cleanup system suction line 6 and cooling the water, then, returning the cooled suppression pool water 4 to the suppression pool 3 through the suppression pool water cleanup system discharge line 20.

An outlet valve of the heat exchanger for cooling suppression pool water 11 is installed on the suppression pool water cooling line 18 on the outlet side of the heat exchanger for cooling suppression pool water 5.

It is preferable that the heat exchanger for cooling suppression pool water 5 is installed in a position which can be easily accessed from the outside of a reactor building (not shown).

Also in the embodiment, a temperature measuring device 25 for measuring the temperature of the suppression pool water 4 is installed in the suppression pool 3, and there is provided a controller 26, to which a signal is transmitted when the temperature measuring device 25 measures that the temperature of the suppression pool water 4 has reached the vicinity of the maximum use temperature (for example, 104° C.) of the suppression pool 3. The controller 26 which has received the signal transmits a signal for opening the suppression pool isolation valves 8, the suppression pool water cleanup system pump inlet valve 9 and the outlet valve 10, and the outlet valve of the heat exchanger for cooling suppression pool water 11, a signal for closing the fuel pool cooling and cleanup system line inlet valve 14 and the outlet valve 19, the suppression pool water cleanup system surveillance line valve 12 and the fuel pool line inlet valve 13 and a signal for activating the suppression pool water cleanup system pump 7. The suppression pool water 4 inside the suppression pool 3 is sent to the heat exchanger for cooling suppression pool water 5 by opening/closing respective valves and by activating the suppression pool water cleanup system pump 7.

The suppression pool water 4 sent to the heat exchanger for cooling suppression pool water 5 is cooled by heat exchange with a coolant in the heat exchanger for cooling suppression pool water 5, and the cooled suppression pool water 4 is returned to the suppression pool 3 through the suppression pool water cleanup system discharge line 20.

The above-described opening and closing operations of respective valves and activation of the pump and so on may be performed by a control mechanism which can be also operated manually according to judgement of an operator.

According to the above embodiment, in the case where the event surpassing the postulated initiating event occurs or when the cooling of the suppression pool water 4 by the residual heat removal system does not function, the suppression pool water 4 can be cooled by the heat exchanger for cooling suppression pool water 5 installed on the suppression pool water cooling line 18, which improves safety of the reactor and reinforces the defense in depth.

### Embodiment 2

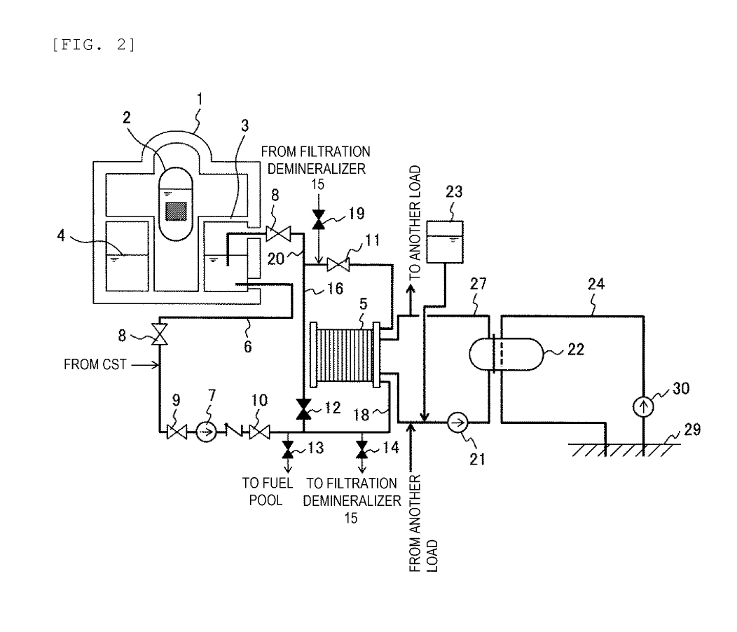

FIG. 2 shows Embodiment 2 of a cooling system of a reactor suppression pool according to the present invention.

The embodiment shown in FIG. 2 is an example of a system configuration in which heat of the suppression pool water 2 is exhausted to service water after performing heat exchange by using the heat exchanger for cooling suppression pool water 5 as in Embodiment 1.

The fuel pool cooling and cleanup system line 17, the filtration demineralizer 15, the temperature measuring device 25 and the controller 26 shown in Embodiment 1 are omitted in embodiments after Embodiment 2 (FIG. 2).

In the embodiment shown in the drawing, a reactor building closed cooling water system line 27 supplying a coolant (water) performing heat exchange with the suppression pool water 4 for cooling is connected to the heat exchanger for cooling suppression pool water 5. The reactor building closed cooling water system line 27 includes a reactor building closed cooling water system pump 21, a reactor building closed cooling water system heat exchanger 22 and a reactor building closed cooling water system surge tank 23. In the reactor building closed cooling water system heat exchanger 22, there is installed a reactor service water system line 24 pumping up a service water 29 by a reactor service water system pump 30 and performing heat exchange with a coolant by the reactor building closed cooling water system heat exchanger 22 to exhaust heat to the service water 29.

That is, when the cooling of the suppression pool water 4 is started as in Embodiment 1, it is necessary that the heat exchanger for cooling suppression pool water 5 performs heat exchange between the high-temperature suppression pool water 4 and the coolant. Therefore, the heat exchanger for cooling suppression pool water 5 is connected to the reactor building closed cooling water system line 27 including the reactor building closed cooling water system pump 21, the reactor building closed cooling water system heat exchanger 22 and the reactor building closed cooling water system surge tank 23 so that the coolant (water) flows therethrough. Furthermore, the reactor building closed cooling water system line 27 is connected to the reactor service water system line 24 using the service water 29 as a secondary coolant to thereby perform heat exchange between the coolant (water) and the service water 29 by the reactor building closed cooling water system heat exchanger 22.

According to the above embodiment, heat of the suppression pool water 4 is discharged to the service water 29, therefore, the same effects as Embodiment 1 can be obtained as well as stable cooling can be performed.

### Embodiment 3

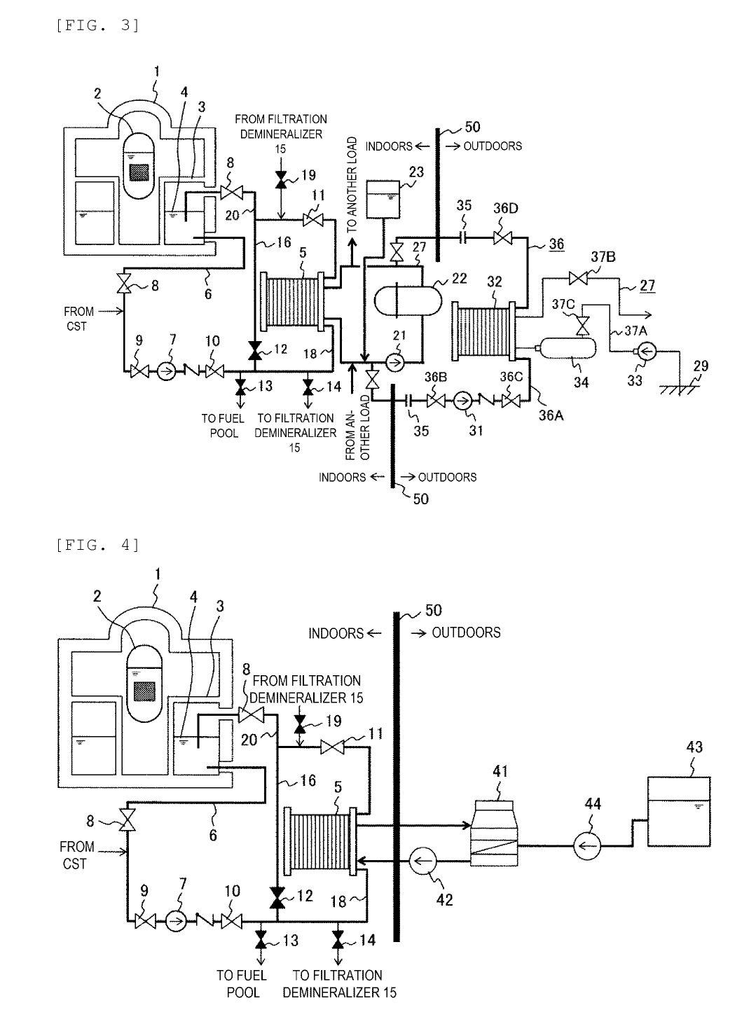

FIG. 3 shows Embodiment 3 of a cooling system of a reactor suppression pool according to the present invention.

The embodiment shown in FIG. 3 is an example of a system configuration in which cooling of the suppression pool 3 is performed stably in preparation for a case where the reactor building closed cooling water system line 27 and the reactor service water system line 24 used in Embodiment 2 are not able to be used due to some reasons.

In the embodiment shown in the drawing, an alternative reactor building closed cooling water unit 36 in the outside of a reactor building 50 is connected to the reactor building closed cooling water system line 27 through a reactor building outside flange 35 as well as provisional service water pump equipment 37 is connected to the alternative reactor building closed cooling water unit 36, in addition to the configuration of Embodiment 2.

The above alternative reactor building closed cooling water unit 36 is formed of a line including an alternative reactor building closed cooling water pump 31, an alternative reactor building closed cooling water heat exchanger 32, a pipe 36A connecting the above respective components and valves 36B, 36C and 36D. On the other hand, the provisional service water pump equipment 37 is formed of a line including a provisional service water pump 33, a provisional strainer 34, a pipe 37A connecting the above respective components and valves 37B and 37C.

Then, the coolant from the reactor building closed cooling water system line 27 is introduced to the alternative reactor building closed cooling water heat exchanger 32 by the alternative reactor building closed cooling water pump 31. The coolant introduced to the alternative reactor building closed cooling water heat exchanger 32 and the service water 29 pumped up by the provisional service water pump 33 and introduced to the alternative reactor building closed cooling water heat exchanger 32 through the provisional strainer 34 perform heat exchange, thereby exhausting the heat to the service water 29.

That is, the heat exchanger for cooling suppression pool water 5 is connected to the reactor building closed cooling water system line 27 according to Embodiment 2, the reactor building closed cooling water system line 27 is connected to the alternative reactor building closed cooling water unit 36 in the outside of the reactor building 50 and the alternative reactor building closed cooling water unit 36 is connected to the provisional service water pump equipment 37, thereby discharging the heat of the suppression pool water 4 in the suppression pool 3 into the service water 29.

According to the above embodiment, the same effects as Embodiment 2 can be obtained as well as stable cooling can be performed.

### Embodiment 4

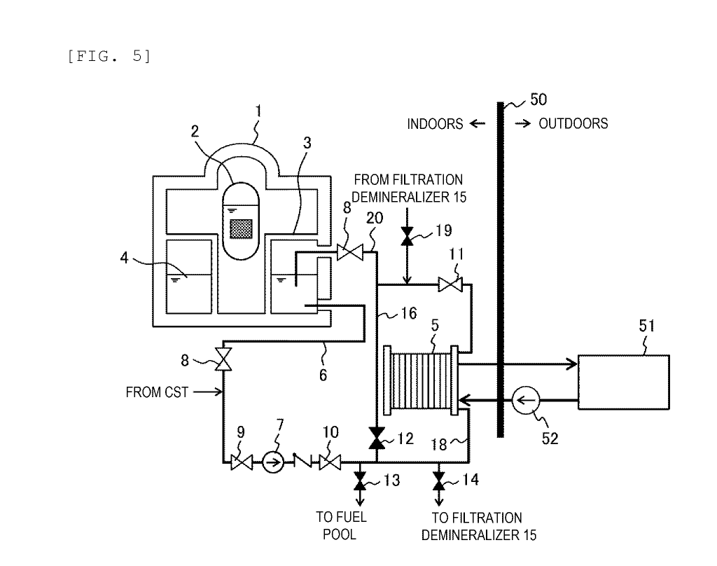

FIG. 4 shows Embodiment 4 of a cooling system of a reactor suppression pool according to the present invention.

The embodiment shown in FIG. 4 is an example of a system configuration in which the heat of the suppression pool water 4 obtained by heat exchange using the heat exchanger for cooling suppression pool water 5 in Embodiment 1 is exhausted to the air by using a cooling tower cooling system.

That is, in the embodiment shown in the drawing, the cooling tower cooling system is connected to the heat exchanger for cooling suppression pool water 5, which is formed of a cooling tower 41 installed in the outside of the reactor building 50 for performing heat exchange between the suppression pool water 4 and a circulating water of the cooling tower cooling system in the heat exchanger for cooling suppression pool water 5, and a circulating pump 42 for circulating the circulating water of the cooling tower cooling system in a loop closed between the cooling tower 41 and the heat exchanger for cooling suppression pool water 5. Moreover, a makeup water source 43 which supplies makeup water to be vaporized for performing heat exchange with the circulating water of the cooling tower cooling system by latent heat of vaporization by vaporizing the makeup water by the cooling tower 41, and a makeup water pump 44 feeding the makeup water from the makeup water source 43 to the cooling tower 41 are connected to the cooling tower 41.

The suppression pool water 4 of the suppression pool 3 is cooled as the heat of the suppression pool water 4 is discharged to the air through the circulating water of the cooling tower cooling system and the cooling tower 41.

That is, the circulating water of the cooling tower cooling system is allowed to flow into the heat exchanger for cooling suppression pool water 5, thereby performing heat exchange with the suppression pool water 4, as a result, the heat of the suppression pool water 4 is discharged to the air through the circulation water of the cooling tower cooling system and the cooling tower 41.

According to the above embodiment, the same effects as Embodiment 1 can be obtained as well as stable cooling can be performed.

### Embodiment 5

FIG. 5 shows Embodiment 5 of a cooling system of a reactor suppression pool according to the present invention.

The embodiment shown in FIG. 5 is an example of a system configuration in which the heat of the suppression pool water 4 obtained by heat exchange using the heat exchanger for cooling suppression pool water 5 in Embodiment 1 is exhausted to the air by using an air fin cooler cooling system.

That is, in the embodiment shown in the drawing, the air fin cooler cooling system is connected to the heat exchanger for cooling suppression pool water 5, which is formed of an air fin cooler 51 installed in the outside of the reactor building 50 for performing heat exchange with the air through the suppression pool water 4 and a circulating water of the air fin cooler cooling system in the heat exchanger for cooling suppression pool water 5, and a circulating pump 52 for circulating the circulating water of the air fin cooler cooling system in a loop closed between the air fin cooler 51 and the heat exchanger for cooling suppression pool water 5.

The suppression pool water 4 of the suppression pool 3 is cooled as the heat of the suppression pool water 4 is discharged to the air through the circulating water of the air fin cooler cooling system and the air fin cooler 51.

That is, the circulating water of the air fin cooler cooling system is allowed to flow into the heat exchanger for cooling suppression pool water 5, thereby performing heat exchange with the suppression pool water 4, as a result, the heat of the suppression pool water 4 is discharged to the air through the circulation water of the air fin cooler cooling system and the air fin cooler 51.

According to the above embodiment, the same effects as Embodiment 1 can be obtained as well as stable cooling can be performed.

The present invention is not limited to the above embodiments and various modification examples are included.

For example, the above embodiments have been explained in detail for clearly explaining the present invention, and are not always limited to embodiments including all explained components. It is possible to replace part of components of a certain embodiment with components of another embodiment as well as to add components of a certain embodiment to components of another embodiment. Also, addition, omission and replacement may occur in part of components in respective embodiments.

### REFERENCE SIGNS LIST

1 . . . reactor containment vessel, 2 . . . reactor, 3 . . . suppression pool, 4 . . . suppression pool water, 5 . . . heat exchanger for cooling suppression pool water, 6 . . . suppression pool water cleanup system suction line, 7 . . . suppression pool water cleanup system pump, 8 . . . suppression pool isolation valve, 9 . . . suppression pool water cleanup system pump inlet valve, 10 . . . suppression pool water cleanup system pump outlet valve, 11 . . . outlet valve of the heat exchanger for cooling suppression pool water, 12 . . . suppression pool water cleanup system surveillance line valve, 13 . . . fuel pool line inlet valve, 14 . . . fuel pool cooling and cleanup system line inlet valve, 15 . . . filtration demineralizer, 16 . . . suppression pool water cleanup system surveillance line, 17 . . . fuel pool cooling and cleanup system line, 18 . . . suppression pool water cooling line, 19 . . . fuel pool cooling and cleanup system line outlet valve, 20 . . . suppression pool water cleanup system discharge line, 21 . . . reactor building closed cooling water system pump, 22 . . . reactor building closed cooling water system heat exchanger, 23 . . . reactor building closed cooling water system surge tank, 24 . . . reactor service water system line, 25 . . . temperature measuring device, 26 . . . controller, 27 . . . reactor building closed cooling water system line, 29 . . . service water, 30 . . . reactor service water system pump, 31 . . . alternative reactor building closed cooling water pump, 32 . . . alternative reactor building closed cooling water heat exchanger, 33 . . . provisional service water pump, 34 . . . provisional strainer, 35. . .reactor building outside flange, 36 . . . alternative reactor building closed cooling water unit, 36A, 37A . . . pipe, 36B, 36C, 36D, 37B, 37C . . . valve, 37 . . . provisional service water pump equipment, 41 . . . cooling tower, 42 . . . circulating pump of cooling tower cooling system, 43 . . . makeup water source, 44 . . . makeup water pump, 50 . . . reactor building, 51 . . . air fin cooler, 52 . . . circulating pump of air fin cooler cooling system

1. A cooling system of a reactor suppression pool for cooling a suppression water stored in the suppression pool arranged in a reactor containment vessel in which a reactor is housed, comprising:
a suppression pool water cleanup system suction line sucking the suppression pool water from the suppression pool and allows the water to flow;
a suppression pool water cleanup system pump installed in the middle of the suppression pool water cleanup system suction line;
a fuel pool cooling and cleanup system line one end of which is connected to the suppression pool water cleanup system suction line;
a filtration demineralizer installed in the middle of the fuel pool cooling and cleanup system line and cleaning up the suppression pool water flowing in the fuel pool cooling and cleanup system line;
a suppression pool water cleanup system discharge line connected to the other end of the fuel pool cooling and cleanup system line and returning the suppression pool water cleaned up by the filtration demineralizer to the suppression pool;
a suppression pool water cooling line one end of which is connected to a line connecting between the suppression pool water cleanup system suction line and the fuel pool cooling and cleanup system line on an inlet side to the filtration demineralizer and the other end of which is connected to a line connecting between the fuel pool cooling and cleanup system line on an outlet side to the filtration demineralizer and the suppression pool water cleanup system discharge line; and
a heat exchanger for cooling suppression pool water installed in the middle of the suppression pool water cooling line, operating when the temperature of the suppression pool water reaches a given temperature, performing heat exchange with the suppression pool water from the suppression pool water cleanup system suction line to cool the water, and returning the cooled suppression pool water to the suppression pool through the suppression pool water cleanup system discharge line.

2. The cooling system of the reactor suppression pool according to claim 1, further comprising:
a temperature measuring device for measuring the temperature of the suppression pool water,
wherein heat exchanger for cooling suppression pool water operates when the temperature measuring device measures that the temperature of the suppression pool water has reached the vicinity of the maximum use temperature of the suppression pool.

3. The cooling system of the reactor suppression pool according to claim 2, further comprising:
suppression pool isolation valves in the suppression pool water cleanup system suction line and the suppression pool water cleanup system discharge line;
a suppression pool water cleanup system pump inlet valve and a suppression pool water cleanup system pump outlet valve on an inlet side and an outlet side of the suppression pool water cleanup system pump;
an outlet valve of the heat exchanger for cooling suppression pool water on the suppression pool water cooling line on an outlet side of the heat exchanger for cooling suppression pool water;
a fuel pool cooling and cleanup system line inlet valve and a fuel pool cooling and cleanup system line outlet valve in the fuel pool cooling and cleanup system line on the inlet side and the outlet side of the filtration demineralizer; and
a controller opening the suppression pool isolation valves, the suppression pool water cleanup system pump inlet valve and the outlet valve and the outlet valve of the heat exchanger for cooling suppression pool water as well as closing the fuel pool cooling and cleanup system line inlet valve and the outlet valve when the temperature measuring device measures that the temperature of the suppression pool water has reached the vicinity of the maximum use temperature of the suppression pool.

4. The cooling system of the reactor suppression pool according to claim 1,
wherein the suppression pool water cleanup system suction line and the suppression pool water cleanup system discharge line are connected by a suppression pool water cleanup system surveillance line used at the time of performing a performance validation test of the suppression pool water cleanup system pump, and
a suppression pool water cleanup system surveillance line valve which is closed when the heat exchanger for cooling suppression pool water operates is provided in the middle of the suppression pool water cleanup system surveillance line.

5. The cooling system of the reactor suppression pool according to claim 1,
wherein a reactor building closed cooling water system line supplying a coolant performing heat exchange with the suppression pool water for cooling is connected to the heat exchanger for cooling suppression pool water,
the reactor building closed cooling water system line includes a reactor building closed cooling water system pump, a reactor building closed cooling water system heat exchanger and a reactor building closed cooling water system surge tank, and
a reactor service water system line pumping up a service water by a reactor service water system pump and performing heat exchange with the coolant by the reactor building closed cooling water system heat exchanger to exhaust heat to the service water is installed in the reactor building closed cooling water system heat exchanger.

6. The cooling system of the reactor suppression pool according to claim 5,
wherein an alternative reactor building closed cooling water unit in the outside of a reactor building is connected to the reactor building closed cooling water system line,
provisional service water pump equipment is connected to the alternative reactor building closed cooling water unit,
the alternative reactor building closed cooling water unit is formed of a line including an alternative reactor building closed cooling water pump, an alternative reactor building closed cooling water heat exchanger, a pipe connecting the above respective components and valves, whereas, the provisional service water pump equipment is formed of a line including a provisional service water pump, a provisional strainer, a pipe connecting the above respective components and valves,
the coolant from the reactor building closed cooling water system line is introduced to the alternative reactor building closed cooling water heat exchanger by the alternative reactor building closed cooling water pump,
the coolant introduced to the alternative reactor building closed cooling water heat exchanger and the service water pumped up by the provisional service water pump and introduced to the alternative reactor building closed cooling water heat exchanger through the provisional strainer perform heat exchange, thereby exhausting the heat to the service water.

7. The cooling system of the reactor suppression pool according to claim 1,
wherein a cooling tower cooling system is connected to the heat exchanger for cooling suppression pool water, which is formed of a cooling tower installed outdoors for performing heat exchange between the suppression pool water and a circulating water in the heat exchanger for cooling suppression pool water, and a circulating pump for circulating the circulating water in a loop closed between the cooling tower and the heat exchanger for cooling suppression pool water, and
the suppression pool water is cooled as the heat of the suppression pool water is discharged to the air through the circulating water and the cooling tower.

8. The cooling system of the reactor suppression pool according to claim 7,
wherein a makeup water source which supplies makeup water to be vaporized for performing heat exchange with the circulating water by latent heat of vaporization by vaporizing the makeup water by the cooling tower, and a makeup water pump which feeds the makeup water from the makeup water source to the cooling tower are connected to the cooling tower.

9. The cooling system of the reactor suppression pool according to claim 1,
wherein an air fin cooler cooling system is connected to the heat exchanger for cooling suppression pool water, which is formed of an air fin cooler installed outdoors for performing heat exchange with the air through the suppression pool water and a circulating water in the heat exchanger for cooling suppression pool water, and a circulating pump for circulating the circulating water in a loop closed between the air fin cooler and the heat exchanger for cooling suppression pool water, and
the suppression pool water is cooled as the heat of the suppression pool water is discharged to the air through the circulating water and the air fin cooler.
